(19) United States
(12) Patent Application Publication
(10) Pub. No.: US 2024/0042554 A1
(43) Pub. Date: Feb. 8, 2024

(54) PRECISION MACHINING APPARATUS AND METHOD FOR MACHINING CONTROLLABLE-HOLE-TYPE MULTIPLE HOLES USING ULTRAFAST LASER

(71) Applicant: XI'AN JIAOTONG UNIVERSITY, Xi'an (CN)

(72) Inventors: Jianlei CUI, Xi'an (CN); Jingji XU, Xi'an (CN); Xuesong MEI, Xi'an (CN); Herui XIE, Xi'an (CN); Zheng SUN, Xi'an (CN); Bin LIU, Xi'an (CN); Zhengjie FAN, Xi'an (CN); Wenjun WANG, Xi'an (CN)

(21) Appl. No.: 18/455,645

(22) Filed: Aug. 25, 2023

Related U.S. Application Data
(63) Continuation of application No. PCT/CN2022/102275, filed on Jun. 29, 2022.

(30) Foreign Application Priority Data
Dec. 10, 2021 (CN) 202111510708.8

(51) Int. Cl. B23K 26/382; B23K 26/0622

(52) U.S. Cl. CPC B23K 26/382; B23K 26/0624

(57) ABSTRACT

The present disclosure discloses a precision machining apparatus and method for machining controllable-hole-type multiple holes using an ultrafast laser, which is applied in the field of laser precision machining. The apparatus is composed of an ultrafast laser, a laser displacement sensor, a reflector, a focusing lens, a three-dimensional numerical control movement platform A, a three-dimensional numerical control movement platform B, a manual swing slide table, a numerical control rotatable table, a frock clamp, and a computer controller. The principle of this technical solution is that a laser beam is immobile, and a workpiece is driven by the numerical control rotatable table to rotate for drilling a hole. A diameter of the hole is mainly determined by a distance between an optical axis of the laser beam and a rotation axis of the numerical control rotatable table.

### CROSS-REFERENCE TO RELATED APPLICATIONS

This application is a continuation of International Application No. PCT/CN2022/102275, filed on Jun. 29, 2022, which claims priority to Chinese Patent Application No. 202111510708.8, filed on Dec. 10, 2021, both of which are hereby incorporated by reference in their entireties.

### FIELD

The present disclosure relates to the field of laser precision machining, and more particularly, to a precision machining apparatus and method for machining controllable-hole-type multiple holes using an ultrafast laser.

### BACKGROUND

Nowadays, with the continuous maturity and rapid development of laser technology, coupled with the advantages of non-direct contact, no material selection, no mechanical stress, precision machining, good quality, high efficiency, and the like, lasers are increasingly used in industrial fields such as micro and small hole machining and fine cutting. For example, traditional machine drilling is difficult to provide a tiny and durable drill bit. Therefore, the drill bit in the traditional machine drilling is easy to break and difficult to remove chips during drilling of a hole with a large depth-to-diameter ratio, and is difficult to machine hard and brittle materials. Electric spark drilling can only machine conductive materials and forms a recast layer on a machined surface. Compared with these cases, laser drilling has shown itself to be an unparalleled advantage and is gradually playing an indispensable role.

At present, holes machined processed by continuous laser and long pulse laser have larger hole sizes, poor quality and poor accuracy. In contrast, an ultrafast laser beam excels at machining fine structures and obtains high quality accuracy. However, as most of laser beams emitted by an ultrafast laser are currently linearly polarized Gaussian beams, holes machined directly by the laser beams emitted by the ultrafast laser are often tapered with large inlets and small outlets, making straight holes impossible. Moreover, rotary-cut holes or spiral machined holes are out of round and become flattened, and a direction of flattening is related to a direction of linear polarization. Therefore, the laser drilling is more difficult for precise control of the type of hole.

For these problems, linearly polarized lights are adjusted as circular polarization lights for drilling a hole currently by adding

$$\frac{λ}{4}$$

of wave plate, which can solve a roundness problem of the outlet. The roundness problem is predominantly settled by using an inclined laser beam rotary head with a multi optical wedge. However, this unit requires high precision, is difficult to manufacture and is expensive. There is also a small amount of research on an inclined rotatable table for drilling. However, only preliminary ideas have been presented, and no concrete and feasible operational solutions are given. The inclined rotatable table has poor control over the type of hole and is difficult to machine the same two holes repeatedly.

### SUMMARY

To tackle the above problems, the present disclosure provides a precision machining apparatus and method for machining controllable-hole-type multiple holes using an ultrafast laser, which can achieve precise control of taper, diameter, type, multiple holes machining, and consistency of micro-holes on a workpiece with simple and efficient operation.

To achieve the above purposes, the present disclosure is implemented by using the following technical solutions.

Provided is a precision machining apparatus for machining controllable-hole-type multiple holes using an ultrafast laser. The apparatus includes an ultrafast laser, a laser displacement sensor, a numerical control movement platform, and a computer controller. The ultrafast laser is configured to generate a laser beam. The laser beam sequentially passes through a reflector and a focusing lens to be converged on a workpiece. The laser displacement sensor is configured to emit a laser beam with an incident angle of 45° on the reflector. The laser beam emitted by the laser displacement sensor is coaxial with the laser beam emitted by the ultrafast laser after reflected by the reflector. The workpiece is fixed onto the numerical control movement platform through a frock clamp. The computer controller is configured to be connected to the ultrafast laser and the numerical control movement platform to control the ultrafast laser and the numerical control movement platform.

The present disclosure is further improved in that the numerical control movement platform includes a three-dimensional numerical control movement platform A, a manual swing slide table, a numerical control rotatable table, and a three-dimensional numerical control movement platform B. The three-dimensional numerical control movement platform A is configured to allow for movements in three directions along an x-axis, a y-axis, and a z-axis. The manual swing slide table is mounted and fixed on the three-dimensional numerical control movement platform A through a threaded connection. The manual swing slide table is configured to be swingable about the y-axis by a maximum swing angle of ±10° with a resolution of 5′. The numerical control rotatable table is mounted and fixed on the manual swing slide table through the threaded connection. The numerical control rotatable table has a maximum rotational speed of 12 s/r and a rotation angle resolution of 1′. The three-dimensional numerical control movement platform B is mounted and fixed on the numerical control rotatable table through the threaded connection. The three-dimensional numerical control movement platform B is configured to be movable in the three directions along the x-axis, the y-axis, and the z-axis. The frock clamp is mounted and fixed on the three-dimensional numerical control movement platform B through the threaded connection.

The present disclosure is further improved in that the ultrafast laser is a femtosecond laser having a wavelength of 800 nm, a repetition frequency of 1000 Hz, and a maximum power of 4 W.

The present disclosure is further improved in that the reflector is a reflector having a single-wavelength of 800 nm, and the incident angle of the laser beam on the reflector is 45°.

The present disclosure is further improved in that the focusing lens is a plano-convex lens with a focal length of 200 mm.

The present disclosure is further improved in that the laser displacement sensor is configured to emit a laser beam with a wavelength of 650 nm, and measure a distance to an inclined surface from the laser displacement sensor with a resolution of 10 μm in a measurement range of 300 mm, the laser displacement sensor is located above the reflector.

The present disclosure is further improved in that the frock clamp includes a lower support, an upper support, and a bolt, the lower support having a height of h₄ greater than a height of the upper support, and the workpiece is clamped and fixed between the upper support and the lower support through a bolt.

Provided is a precision machining method for machining controllable-hole-type multiple holes using an ultrafast laser based on the precision machining apparatus for machining the controllable-hole-type multiple-holes using the ultrafast-laser as described above. The precision machining method includes: step 1 of determining a focus, the determining the focus including: turning on the ultrafast laser, the laser displacement sensor, the numerical control movement platform, and the computer controller; zeroing a swing angle of the manual swing slide table; determining a position of a focus of the laser beam through a scribing method; and recording a current reading D of the laser displacement sensor, where D=d+f, step 2 of adjusting a rotation axis of the numerical control rotatable table to be coaxial with the laser beam emitted by the ultrafast laser, the adjusting the rotation axis of the numerical control rotatable table to be coaxial with the laser beam emitted by the ultrafast laser including: moving the x-axis and the y-axis of the three-dimensional numerical control movement platform A; aligning the rotation axis of the numerical control rotatable table with an incident laser beam substantially; clamping a test piece on the frock clamp; moving the z-axis of the three-dimensional numerical control movement platform B to position a swing center O of the manual swing slide table on a surface of the test piece, i.e., adjusting h₃ to allow for H=h₁+h₂+h₃+h₄+h₅; moving the z-axis of the three-dimensional numerical control movement platform A to enable the laser displacement sensor to have the reading D, the focus of the laser beam are located on the surface of the test piece when the laser displacement sensor has the reading D; turning on the laser and rotating the numerical control rotatable table by 180°; turning off the laser and measuring distances of Δx and Δy at two ends of a semicircle machining path; and moving the three-dimensional numerical control movement platform A by distances of and

$$\frac{Δ x}{2} and \frac{Δ y}{2}$$

to enable the rotation axis of the numerical control rotatable table to be coaxial with the laser beam emitted by the ultrafast laser; step 3 of determining a machining position, the determining the machining position including: clamping a workpiece onto the frock clamp; determining a machining position on the workpiece based on a spot of the laser beam emitted by the laser displacement sensor; and performing an adjustment through the three-dimensional numerical control movement platform B; step 4 of determining a machining dimension and a type of a to-be-machined hole, the determining the machining dimension and the type of the to-be-machined hole including: setting a swing angle θ of the manual swing slide table and a movement direction of the three-dimensional numerical control movement platform A based on requirements for a taper of the to-be-machined hole; setting a movement distance Δx of the three-dimensional numerical control movement platform A based on requirements for a diameter of the to-be-machined hole, where a radius of the to-be-machined hole satisfies

$$R = \frac{Δ x}{cos θ} + r ,$$

where r represents a radius of a hole punched by the ultrafast laser; and moving the three-dimensional numerical control movement platform A by a distance Δz to compensate for a change in a defocusing amount caused by the movement of the three-dimensional numerical control movement platform A by the movement distance Δx, where Δz=Δx·tan θ, where the laser displacement sensor has the reading D; step 5 of drilling a single hole, the drilling the single hole including: setting the number of rotation and a rotational speed of the numerical control rotatable table; moving the three-dimensional numerical control movement platform A by the distance k and setting the defocusing amount required for the machining; and turning on the ultrafast laser to drill the hole; step 6 of machining multiple holes, the machining the multiple holes including: turning off the ultrafast laser subsequent to machining the single hole; moving the three-dimensional numerical control movement platform B to a next machining station of the workpiece based on the spot of the laser of the laser displacement sensor; and repeating the step 5 and step 6 until the machining for all of the multiple holes is completed; and step 7 of ending the machining, the ending the machining including: removing the machined workpiece subsequent to completing the machining; and turning off all devices.

Compared with the relates art, the present disclosure at least has beneficial technical effects below.
1. The precision machining apparatus for machining the controllable-hole-type multiple holes using the ultrafast laser is designed in the present disclosure, which has a simple structure, low cost, and may realize machining on various types of the hole like determining a taper and diameter of the hole with flexible control and easy operation. In addition, the apparatus may realize machining feed and machining multiple holes with high processing quality and precision, controlled sharpness of edges of holes and excellent consistency.
2. In the present disclosure, the laser beam emitted by the laser displacement sensor may keep coaxial with the laser beam emitted by the ultrafast laser after reflected by the reflector, which may play a role in indicating the spot, and is easy to locate and achieve real-time control of a defocusing amount when the workpiece is inclined, thereby further enhancing the machining precision.
3. The precision machining apparatus for machining the controllable-hole-type multiple holes using the ultrafast laser according to the present disclosure has strong operability and simple process. With the method in the present disclosure, geometric errors and location errors of instruments have been corrected in a preprocessing process of the test piece, and a precision control problem is effectively solved.
4. According to the present disclosure, provided is a manner that the laser beam is immobile, and the workpiece is driven by the numerical control rotatable table to rotate for drilling the hole, which may prevent the problem of flattening the outlet of the hole caused by the linearly polarized lights and the problem of poor roundness of the hole caused by poor quality of the light beam. Meanwhile, compared with drilling the hole by using a scanning galvanometer and the three-dimensional numerical control movement platform, the above manner has no interpolation accuracy problem and has high overall roundness.

### BRIEF DESCRIPTION OF THE DRAWINGS

FIG. 1 is a schematic structural view of a precision machining apparatus for machining controllable-hole-type multiple holes using an ultrafast laser according to the present disclosure.

FIG. 2 is a partial enlarged view of a frock clamp of a precision machining apparatus for machining controllable-hole-type multiple holes using an ultrafast laser according to the present disclosure.

FIG. 3 is a schematic view of a type of a to-be-machined hole of an incident laser relative to a rotation axis of the workpiece at different angles and positions according to the present disclosure.

FIG. 4A is a schematic diagram of calculating a change in a diameter of the hole and a change in a defocusing amount caused by the movement of a three-dimensional numerical control movement platform A moving rightwards by a distance Δx according to the present disclosure.

FIG. 4B is a schematic diagram of calculating a change in a diameter of the hole and a change in a defocusing amount caused by the movement of a three-dimensional numerical control movement platform A moving downwards by a distance Δz according to the present disclosure.

FIG. 5A is a light photomicrograph of a sample graph machined by rotating a numerical control rotatable table by 180° before a coaxial adjustment according to the present disclosure.

FIG. 5B is a light photomicrograph of a sample graph machined by rotating a numerical control rotatable table by 180° after a coaxial adjustment according to the present disclosure.

FIG. 6A is an electron micrograph of an inlet of a taper-free hole according to a machined example of the present disclosure.

FIG. 6B is an electron micrograph of an outlet of a taper-free hole according to a machined example of the present disclosure.

FIG. 7 is a cross-sectional electron micrograph of taper-free hole of 2 mm according to a machined example of the present disclosure.

FIG. 8A is a cross-sectional light photomicrograph of a straight hole of 4.5 mm according to a machined example of the present disclosure.

FIG. 8B is a cross-sectional light photomicrograph of a contractive-expanded hole of 4.5 mm according to a machined example of the present disclosure.

Reference numerals in the drawings are described below.
1—three-dimensional numerical control movement platform A, 2—manual swing slide table, 3—numerical control rotatable table, 4—three-dimensional numerical control movement platform B, 5—frock clamp, 6—workpiece, 7—focusing lens, 8—reflector, 9—laser beam A, 10—laser displacement sensor, 11—laser beam B, 12—ultrafast laser, 13—computer controller, 51—upper support block, 52—bolt, 53—lower support block.

### DETAILED DESCRIPTION

Exemplary embodiments of the present disclosure will be described in more detail below with reference to the accompanying drawings. The exemplary embodiments of the present disclosure are illustrated in the accompanying drawings, it should be understood, however, that the present disclosure may be embodied in various forms and should not be construed as being limited to the embodiments set forth herein. Instead, these embodiments are provided for a complete and thorough understanding of the present disclosure, and can fully convey the scope of the present disclosure to those skilled in the art. It should be noted that embodiments of the present disclosure and features disclosed in the embodiments of the present disclosure can be combined with each other without conflicting.

As illustrated in FIG. 1, the present disclosure provides a precision machining apparatus and method for machining controllable-hole-type multiple holes using an ultrafast laser. The apparatus includes an ultrafast laser 12, a laser displacement sensor 10, a reflector 8, a focusing lens 7, a three-dimensional numerical control movement platform A1, a manual swing slide table 2, a numerical control rotatable table 3, a three-dimensional numerical control movement platform B4, a frock clamp 5, a workpiece 6, and a computer controller 13.

The laser beam B11 is emitted by the ultrafast laser 12 and is reflected after being incident to the reflector 8 at 45°. The laser beam A9 is emitted by the laser displacement sensor 10 and is transmitted after being incident to the reflector 8 at 45°. The reflector 8 is a reflector having a single-wavelength of 800 nm and may be pervious to light in the rest of bands. The reflected laser beam B11 and coaxial with the transmission laser beam A9 remain coaxial and are converged onto a surface of the workpiece 6 after passing through the focusing lens 7. The workpiece 6 is clamped by the frock clamp 5. The frock clamp 5 is mounted and fixed on the three-dimensional numerical control movement platform B4 through a threaded connection. The three-dimensional numerical control movement platform B4 is mounted and fixed on the numerical control rotatable table 3 through the threaded connection. The numerical control rotatable table 3 is mounted and fixed on the manual swing slide table 2 through the threaded connection. The manual swing slide table 2 is mounted and fixed on the three-dimensional numerical control movement platform A1 through the threaded connection. A movement platform of a machining system is formed by the three-dimensional numerical control movement platform A1, the manual swing slide table 2, the numerical control rotatable table 3, the three-dimensional numerical control movement platform B4, and the frock clamp 5, which may realize eight-axis movement of the workpiece 6 including six prismatic pairs and two revolute pairs. Two rotational degrees of freedom are provided by the numerical control rotatable table 3 and the manual swing slide table, which may achieve rotary-cut drilling and inclined drilling of the workpiece 6. Holes with different tapers may be generated at different angles of inclination. Six rotational degrees of freedom are provided by the three-dimensional numerical control movement platform A1 and the three-dimensional numerical control movement platform B4, which may control a machining position, a drilling diameter and type of the workpiece 6, and satisfy the requirement for machining the multiple holes. The computer controller 13 is configured to be connected to the ultrafast laser 12 and the three-dimensional numerical control movement platform A1, the numerical control rotatable table 3, and the three-dimensional numerical control movement platform B4. The laser displacement sensor 10 may play a role in indicating a spot and monitor states of the defocusing amount caused by transmitting the laser beam to the surface of the workpiece at different positions and angles in real time, helping to ensure precise location.

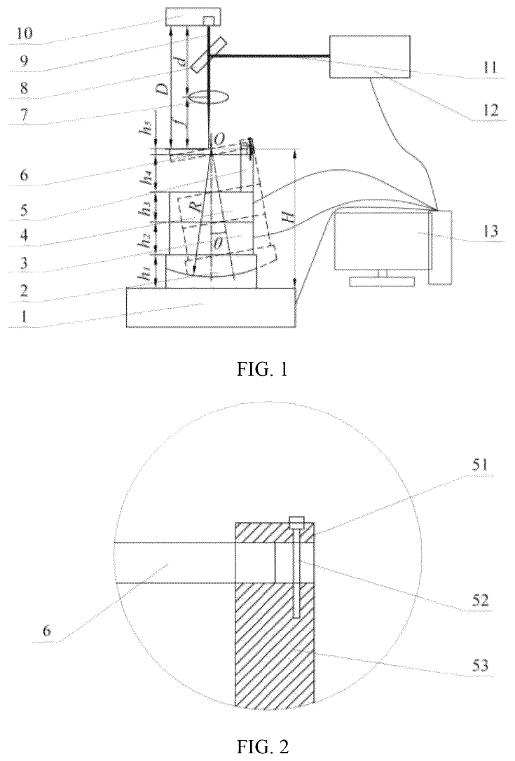

FIG. 2 is a partial enlarged view of a frock clamp 5 according to the present disclosure. The frock clamp includes an upper support block 51, a bolt 52, and a lower support block 53. The workpiece is clamped and fixed between the upper support block 51 and the lower support block 53. A threaded hole is arranged between the upper support block 51 and the lower support block 53. The workpiece 6 is clamped and fixed by tightening the bolt 52 on the threaded hole.

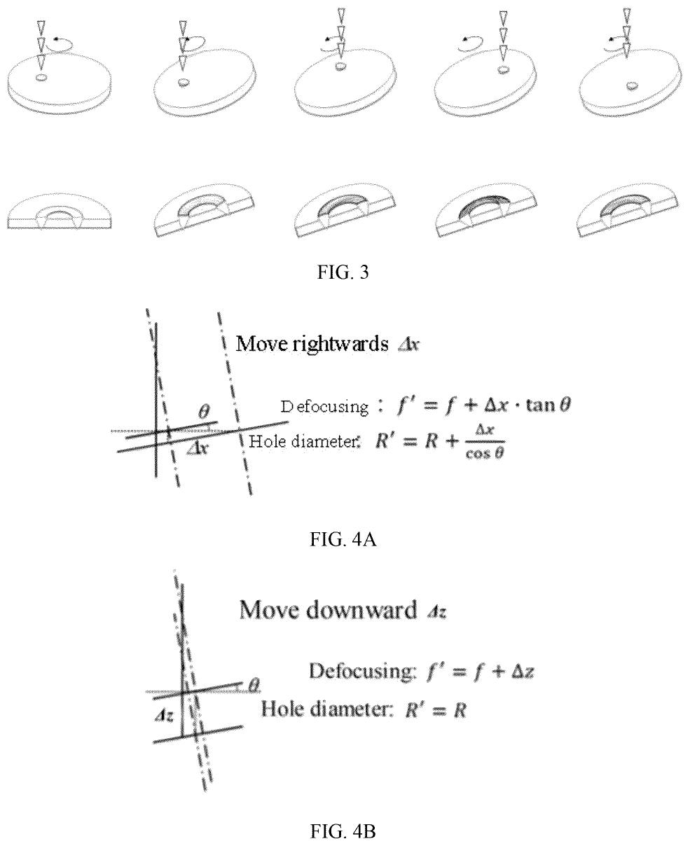

As illustrated in FIG. 3, when a swing angle of the manual swing slide table 2 is 0 and the workpiece 6 is horizontally placed, a positive taper hole with a big inlet and a small outlet is generated because of the Gaussian energy distribution of a fast laser beam B11 and a factor of light beam shielding in a deep hole. When the manual swing slide table 2 swings rightwards by a predetermined angle, the workpiece 6 inclines leftwards, and the laser beam B11 is incident in the western part of a cross-point O of the surface of the workpiece 6 and the rotation axis of the numerical control rotatable table 3, a positive taper of the drilled hole decreases, and even a taper-free hole and a hole with a negative taper may be generated along with the increase of the swing angle. When the manual swing slide table 2 swings rightwards by a predetermined angle, the workpiece 6 inclines leftwards, and the laser beam B11 is incident in the eastern part of the cross-point O of the surface of the workpiece 6 and the rotation axis of the numerical control rotatable table 3, the positive taper of the drilled hole increases. When the manual swing slide table 2 swings rightwards by a predetermined angle, the workpiece 6 inclines leftwards, and the laser beam B11 is incident in the northern part or in the southern part of the cross-point O of the surface of the workpiece 6 and the rotation axis of the numerical control rotatable table 3, the drilled hole is still a hole with the positive taper and a same size of taper as that when the workpiece 6 is horizontally placed.

As illustrated in FIG. 4A and FIG. 4B, the three-dimensional numerical control movement platform A1 is mainly configured to control a drilling diameter and a drilling defocusing amount of the workpiece 6. When the manual swing slide table 2 swings rightwards by θ, the workpiece 6 inclines leftwards by θ, and the laser beam B11 is incident in the western part of the cross-point O of the surface of the workpiece 6 and the rotation axis of the numerical control rotatable table 3, the three-dimensional numerical control movement platform A1 moves rightwards by Δx, the defocusing amount increases by Δx·tan θ, and the diameter of the hole increases by

$$\frac{Δ x}{cos θ} ;$$

or the three-dimensional numerical control movement platform A1 moves downwards by Δx, the defocusing amount increases by A, and the diameter of the hole remains constant.

A specific embodiment is described below.

A precision machining apparatus for machining controllable-hole-type multiple holes using an ultrafast laser according to the present disclosure is used to machine a group of holes composed of five taper-free straight holes on a stainless-steel plate with a thickness of 2 mm, and the five taper-free straight holes have a diameter of ϕ=550 μm and are arranged at intervals of 2 mm in a row. The precision machining method specifically includes the following steps below.

At step 1, a focus is determined. The ultrafast laser 12, the laser displacement sensor 10, the three-dimensional numerical control movement platform A1, the numerical control rotatable table 3, the three-dimensional numerical control movement platform B4, and the computer controller 13 are turned on. A swing angle of the manual swing slide table 2 is zeroed. A focus is determined by a silicon wafer through a scribing method, and a height corresponding to the finest thread is a position of a focus of the laser beam. A current reading D of the laser displacement sensor 10 is recorded as D=243.54.

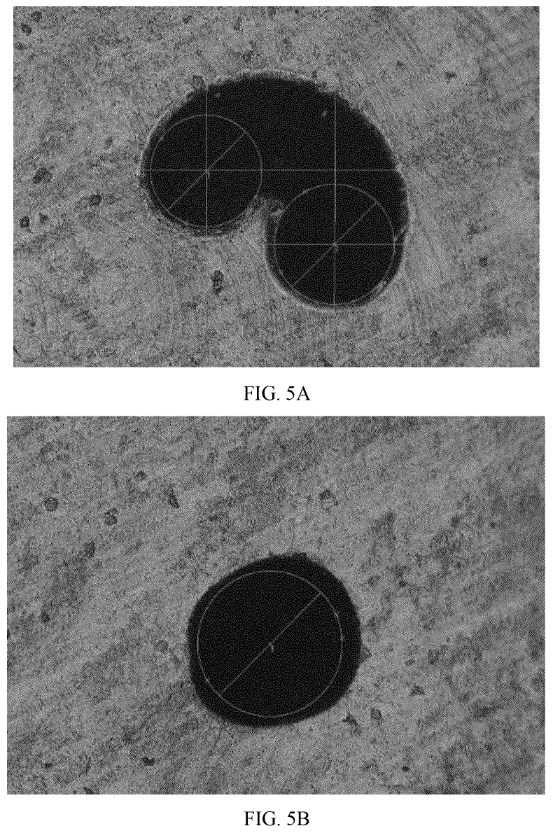

At step 2, a rotation axis of the numerical control rotatable table 3 is adjusted to be coaxial with the laser beam B11 emitted by the ultrafast laser 12. The x-axis and the y-axis of the three-dimensional numerical control movement platform A1 are moved. The rotation axis of the numerical control rotatable table 3 is aligned with an incident laser beam B11 substantially, enabling a swing center O of the manual swing slide table 2 to be located on a surface of the stainless-steel test piece 6 with a thickness of 2 mm. A height of the manual swing slide table 2 is given as h₁=24 mm. A height of the numerical control rotatable table 3 is given as h₂=45 mm. A height of the frock clamp 5 is given as h₄=20 mm. A height of the stainless-steel test piece 6 is given as h₅=2 mm. A height of the swing center of the manual swing slide table 2 is given as H=150 mm. That is, a height of the three-dimensional numerical control movement platform B4 is adjusted as h₃=H−h₁−h₂−h₄−h₅=59 mm. The z-axis of the three-dimensional numerical control movement platform A1 is moved to enable the laser displacement sensor 10 to have the reading D, where D=243.54. The focus of the laser beam B11 is located on the surface of the stainless-steel test piece 6 when the laser displacement sensor 10 has the reading D. The laser B11 is turned on, and the numerical control rotatable table 3 is rotated by 180°. The laser B11 is turned off, and the stainless-steel test piece 6 is taken down to observe and measure distances of Δx and Δy at two ends of a semicircle machining path under an optical microscope in the same orientation of the frock clamp 5. As illustrated in FIG. 5A, in response to Δx=341.17 μm and Δy=198.25 μm, the three-dimensional numerical control movement platform A1 is moved leftwards by a distance of

$$\frac{Δ x}{2} = 170.5 \; 85 μm$$

and moved forwards by a distance of

$$\frac{Δ y}{2} = 99.125 μm$$

to enable the rotation axis of the numerical control rotatable table 3 to be coaxial with the laser beam B11 emitted by the ultrafast laser 12. Currently, the laser B11 is turned on, and the numerical control rotatable table 3 is rotated by 180°. In addition, a graph machined on the stainless-steel test piece 6 under an optical microscope is as illustrated in FIG. 5B where only a round pit can be seen rather than a half arc, indicating that alignment has been achieved.

At step 3, a machining position is determined. A stainless-steel workpiece 6 with a thickness of 2 mm is clamped onto the frock clamp 5. A machining position on the stainless-steel workpiece 6 with the thickness of 2 mm is determined based on a spot of the laser beam A9 emitted by the laser displacement sensor 10. An adjustment is performed through the three-dimensional numerical control movement platform B4.

At step 4, a machining dimension and a type of a to-be-machined hole are determined. The machining dimension of the to-be-machined hole is ϕ=550 μm, and the type of the to-be-machined hole is the taper-free straight hole. The manual swing slide table 2 is set to swing rightwards by an angle of θ=6°. The three-dimensional numerical control movement platform A1 is set to move leftwards by a distance of Δx=(R−r)cos θ. It is given that a radius of the to-be-machined hole is R=275 μm, the swing angle is θ=6°, and a repetition frequency of the laser beam B11 emitted by the ultrafast laser 12 is 1000 Hz. In this case, laser power is set as 2.5 W, and a radius of a hole punched by the ultrafast laser 12 is set as r=146 μm when a negative defocusing amount is 2.5 mm. Therefore, the three-dimensional numerical control movement platform A1 is moved leftwards by a distance of Δx=128.29 μm. Furthermore, the three-dimensional numerical control movement platform A1 is moved by a distance Δz to compensate for a change in a defocusing amount caused by the movement of the three-dimensional numerical control movement platform A1 by the movement distance Δx, where Δz=Δx·tan θ=13.48 μm. At this time, it should be noted that the laser displacement sensor has the reading returning to D=243.54.

At step 5, a single hole is drilled. The number of rotations of the numerical control rotatable table 3 is set as 25 laps. A rotational speed of the numerical control rotatable table 3 is set as 37 s/laps. The three-dimensional numerical control movement platform A1 is moved upwards by the distance of Δz=2.5 mm that is set as the defocusing amount required for the machining. The laser beam B11 is turned on to drill the hole.

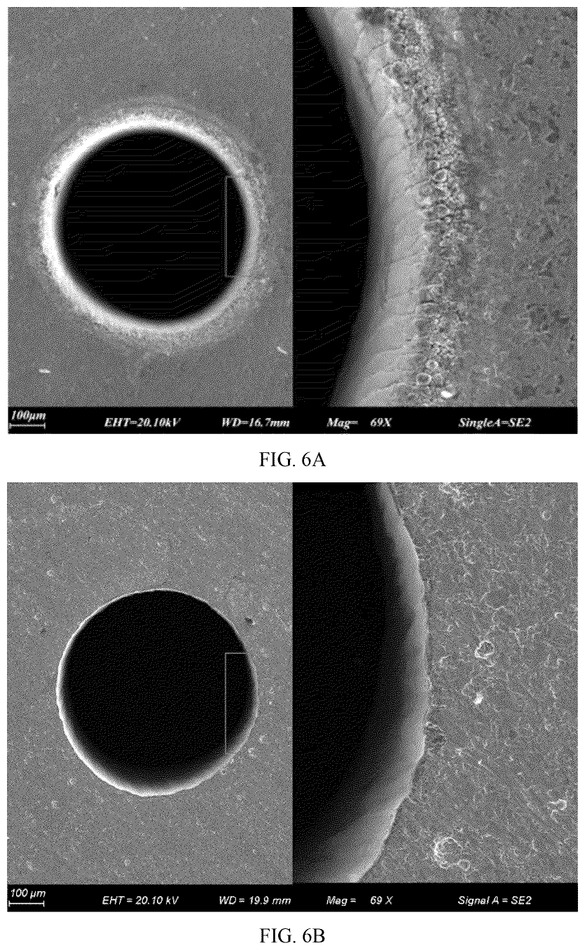

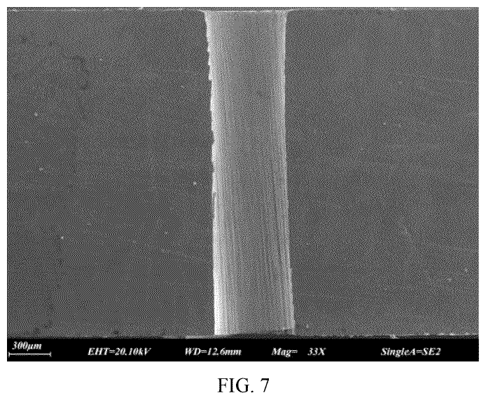

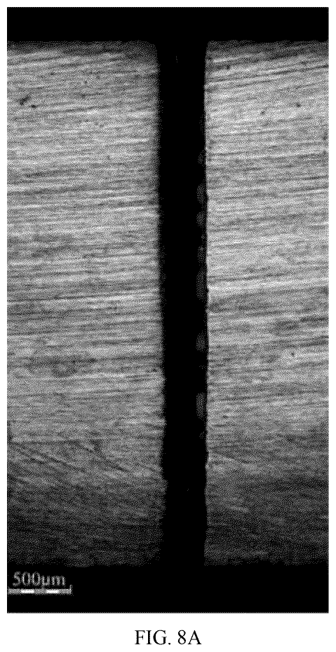

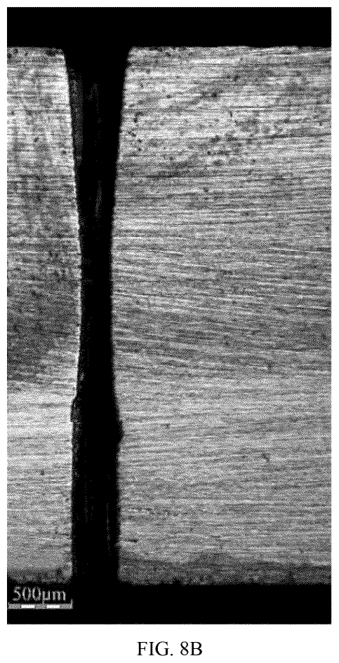

At step 6, multiple holes are machined. The laser beam B11 is turned off subsequent to machining the single hole. The three-dimensional numerical control movement platform B4 is moved by 2 mm in a negative direction towards the x-axis to a next machining station of the stainless-steel workpiece 6 based on the spot of the laser A9 of the laser displacement sensor 10. The step 5 and step 6 are repeated until the machining for the rest four holes is completed. FIG. 6A is an electron micrograph of an inlet of a taper-free hole according to a machined example of the present disclosure. FIG. 6B is an electron micrograph of an outlet of a taper-free hole according to a machined example of the present disclosure. FIG. 7 is a cross-sectional electron micrograph of the machined hole, in which high machining quality and precision of the hole can be seen.

At step 7, the machining is ended. The stainless-steel machined workpiece 6 subsequent to completing the machining is removed, and all devices are turned off.

Although the present disclosure is described in detail with general description and specific implementations, based on the present disclosure, some modifications or improvements may be made thereto. For example, a suitable laser and frock clamp may be selected as required for machining to machine a specific workpiece, or a CCD system may be integrated into an optical path to achieve online observation and measurement, thereby more quickly calibrating the entire optical machine system and positioning processing, and further improving a drilling rate by increasing high-speed circular motion of an ultrafast laser beam. Therefore, it is easily achievable by those of ordinary skill in the art. As a result, these modifications, or improvements, made without departing from the spirit of the present disclosure, fall within the scope of the present disclosure.

What is claimed is:

1. A precision machining apparatus for machining controllable-hole-type multiple holes using an ultrafast laser, comprising:
an ultrafast laser configured to generate a laser beam, the laser beam sequentially passing through a reflector and a focusing lens to be converged on a workpiece;
a laser displacement sensor configured to emit a laser beam with an incident angle of 45° on the reflector, the laser beam emitted by the laser displacement sensor being coaxial with the laser beam emitted by the ultrafast laser after reflected by the reflector;
a numerical control movement platform, the workpiece being fixed onto the numerical control movement platform through a frock clamp; and
a computer controller configured to be connected to the ultrafast laser and the numerical control movement platform to control the ultrafast laser and the numerical control movement platform.

2. The precision machining apparatus for machining the controllable-hole-type multiple holes using the ultrafast laser according to claim 1, wherein the numerical control movement platform comprises:
a three-dimensional numerical control movement platform A configured to allow for movements in three directions along an x-axis, a y-axis, and a z-axis;
a manual swing slide table mounted and fixed on the three-dimensional numerical control movement platform A through a threaded connection, the manual swing slide table being configured to be swingable about the y-axis by a maximum swing angle of ±100 with a resolution of 5′;
a numerical control rotatable table mounted and fixed on the manual swing slide table through the threaded connection, the numerical control rotatable table having a maximum rotational speed of 12 s/r and a rotation angle resolution of 1′; and
a three-dimensional numerical control movement platform B mounted and fixed on the numerical control rotatable table through the threaded connection, the three-dimensional numerical control movement platform B being configured to be movable in the three directions along the x-axis, the y-axis, and the z-axis, the frock clamp being mounted and fixed on the three-dimensional numerical control movement platform B through the threaded connection.

3. The precision machining apparatus for machining the controllable-hole-type multiple holes using the ultrafast-laser according to claim 2, wherein the ultrafast laser is a femtosecond laser having a wavelength of 800 nm, a repetition frequency of 1000 Hz, and a maximum power of 4 W.

4. The precision machining apparatus for machining the controllable-hole-type multiple holes using the ultrafast-laser according to claim 2, wherein the reflector is a reflector having a single-wavelength of 800 nm, and the incident angle of the laser beam on the reflector is 45°.

5. The precision machining apparatus for machining the controllable-hole-type multiple holes using the ultrafast-laser according to claim 2, wherein the focusing lens is a plano-convex lens with a focal length of 200 mm.

6. The precision machining apparatus for machining the controllable-hole-type multiple holes using the ultrafast-laser according to claim 2, wherein the laser displacement sensor is configured to emit a laser beam with a wavelength of 650 nm, and measure a distance to an inclined surface from the laser displacement sensor with a resolution of 10 μm in a measurement range of 300 mm, the laser displacement sensor being located above the reflector.

7. The precision machining apparatus for machining the controllable-hole-type multiple holes using the ultrafast-laser according to claim 2, wherein the frock clamp comprises a lower support, an upper support, and a bolt, the lower support having a height of h₄ greater than a height of the upper support, and the workpiece being clamped and fixed between the upper support and the lower support through a bolt.

8. A precision machining method for machining controllable-hole-type multiple holes using an ultrafast laser, based on the precision machining apparatus for machining the controllable-hole-type multiple-holes using the ultrafast-laser according to claim 2, the precision machining method comprising:
step 1 of determining a focus, said determining the focus comprising:
turning on the ultrafast laser, the laser displacement sensor, the numerical control movement platform, and the computer controller;
zeroing a swing angle of the manual swing slide table;
determining a position of a focus of the laser beam through a scribing method; and
recording a current reading D of the laser displacement sensor, where D=d+f;
step 2 of adjusting a rotation axis of the numerical control rotatable table to be coaxial with the laser beam emitted by the ultrafast laser, said adjusting the rotation axis of the numerical control rotatable table to be coaxial with the laser beam emitted by the ultrafast laser comprising:
moving the x-axis and the y-axis of the three-dimensional numerical control movement platform A;
aligning the rotation axis of the numerical control rotatable table with an incident laser beam substantially;
clamping a test piece on the frock clamp;
moving the z-axis of the three-dimensional numerical control movement platform B to position a swing center O of the manual swing slide table on a surface of the test piece, i.e., adjusting h₃ to allow for H=h₁+h₂+h₃+h₄+h₅;
moving the z-axis of the three-dimensional numerical control movement platform A to enable the laser displacement sensor to have the reading D, the focus of the laser beam being located on the surface of the test piece when the laser displacement sensor has the reading D;
turning on the laser and rotating the numerical control rotatable table by 180°;
turning off the laser and measuring distances of Δx and Δy at two ends of a semicircle machining path; and
moving the three-dimensional numerical control movement platform A by distances of
$$\frac{Δ x}{2} and \frac{Δ y}{2}$$
to enable the rotation axis of the numerical control rotatable table to be coaxial with the laser beam emitted by the ultrafast laser;
step 3 of determining a machining position, said determining the machining position comprising:
clamping a workpiece onto the frock clamp;
determining a machining position on the workpiece based on a spot of the laser beam emitted by the laser displacement sensor, and
performing an adjustment through the three-dimensional numerical control movement platform B;
step 4 of determining a machining dimension and a type of a to-be-machined hole, said determining the machining dimension and the type of the to-be-machined hole comprising:
setting a swing angle θ of the manual swing slide table and a movement direction of the three-dimensional numerical control movement platform A based on requirements for a taper of the to-be-machined hole;
setting a movement distance Δx of the three-dimensional numerical control movement platform A based on requirements for a diameter of the to-be-machined hole, wherein a radius of the to-be-machined hole satisfies
$$R = \frac{Δ x}{cos θ} + r ,$$
where r represents a radius of a hole punched by the ultrafast laser; and
moving the three-dimensional numerical control movement platform A by a distance Δz to compensate for a change in a defocusing amount caused by the movement of the three-dimensional numerical control movement platform A by the movement distance Δx, where Δz=Δx·tan θ, wherein the laser displacement sensor has the reading D;
step 5 of drilling a single hole, said drilling the single hole comprising:
setting the number of rotation and a rotational speed of the numerical control rotatable table;
moving the three-dimensional numerical control movement platform A by the distance Δz and setting the defocusing amount required for the machining; and
turning on the ultrafast laser to drill the hole;
step 6 of machining multiple holes, said machining the multiple holes comprising:
turning off the ultrafast laser subsequent to machining the single hole;
moving the three-dimensional numerical control movement platform B to a next machining station of the workpiece based on the spot of the laser of the laser displacement sensor; and
repeating the step 5 and step 6 until the machining for all of the multiple holes is completed; and
step 7 of ending the machining, said ending the machining comprising:
removing the machined workpiece subsequent to completing the machining; and
turning off all devices.

9. The precision machining method for machining the controllable-hole-type multiple holes using the ultrafast laser according to claim 8, wherein the numerical control movement platform comprises:
a three-dimensional numerical control movement platform A configured to allow for movements in three directions along an x-axis, a y-axis, and a z-axis;
a manual swing slide table mounted and fixed on the three-dimensional numerical control movement platform A through a threaded connection, the manual swing slide table being configured to be swingable about the y-axis by a maximum swing angle of ±100 with a resolution of 5′;
a numerical control rotatable table mounted and fixed on the manual swing slide table through the threaded connection, the numerical control rotatable table having a maximum rotational speed of 12 s/r and a rotation angle resolution of 1′; and
a three-dimensional numerical control movement platform B mounted and fixed on the numerical control rotatable table through the threaded connection, the three-dimensional numerical control movement platform B being configured to be movable in the three directions along the x-axis, the y-axis, and the z-axis, the frock clamp being mounted and fixed on the three-dimensional numerical control movement platform B through the threaded connection.

10. The precision machining method for machining the controllable-hole-type multiple holes using the ultrafast laser according to claim 9, wherein the ultrafast laser is a femtosecond laser having a wavelength of 800 nm, a repetition frequency of 1000 Hz, and a maximum power of 4 W.

11. The precision machining method for machining the controllable-hole-type multiple holes using the ultrafast laser according to claim 9, wherein the reflector is a reflector having a single-wavelength of 800 nm, and the incident angle of the laser beam on the reflector is 45°.

12. The precision machining method for machining the controllable-hole-type multiple holes using the ultrafast laser according to claim 9, wherein the focusing lens is a plano-convex lens with a focal length of 200 mm.

13. The precision machining method for machining the controllable-hole-type multiple holes using the ultrafast laser according to claim 9, wherein the laser displacement sensor is configured to emit a laser beam with a wavelength of 650 nm, and measure a distance to an inclined surface from the laser displacement sensor with a resolution of 10 μm in a measurement range of 300 mm, the laser displacement sensor being located above the reflector.

14. The precision machining method for machining the controllable-hole-type multiple holes using the ultrafast laser according to claim 9, wherein the frock clamp comprises a lower support, an upper support, and a bolt, the lower support having a height of h₄ greater than a height of the upper support, and the workpiece being clamped and fixed between the upper support and the lower support through a bolt.
